(19) United States
(12) Patent Application Publication
(10) Pub. No.: US 2007/0277772 A1
(43) Pub. Date: Dec. 6, 2007

(54) Protective cover structure for rammer

(75) Inventors: Giichi Tanaka, Shiraoka-machin (JP); Yoshinori Harashima, Satte-shi (JP); Kenichi Nagasawa, Hasuda-shi (JP); Kenichi Muramoto, Shiraoka-machi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mikasa Sangyo Co., Ltd., Tokyo (JP)

(21) Appl. No.: 11/704,043

(22) Filed: Feb. 8, 2007

(30) Foreign Application Priority Data
May 31, 2006 (JP) 2006-151060

(51) Int. Cl. F02B 65/00

(52) U.S. Cl. 123/198 E

(57) ABSTRACT

The present invention provides a protective cover structure for a rammer for which a guard cover plate of a power engine in a rammer is molded from a synthetic resin allowing any shape to be freely obtained and having small weight, high strength, and impact absorption ability. The cover plate is configured so that it can be assembled and disassembled by simple operations, has good endurance with respect to severe vibrations and can reduce the damage of the machine body due to the adequate impact absorption ability even when the rammer tumbles.

Front end sections of guard covers disposed on both sides of a power engine are joined and fixed to the front surface section of the crank chamber, lower sections of the rear portions are supported by support frames of a protective stand provided at the lower surface of the power engine, and the rear sections of the rear portions are linked integrally by a linking transverse pole.

### BACKGROUND OF THE INVENTION

1. Field of the Invention

The present invention relates to the improvement of a guard cover for protecting a crank chamber and a power engine of a rammer for compacting a road surface by hitting the road surface with a compaction plate that moves up and down.

2. Description of the Related Art

A rammer has a structure comprising a power engine providing a rotary movement, a leg section extendable below a crank chamber that converts the rotary movement into an up-down movement, and a compaction plate. Therefore, in a stationary state when the compaction plate is supported by the ground, the center of gravity of the machine is positioned in the upper part of the machine body, the posture is unstable, and the machine can easily tumble. The resultant problem is that if the machine is easy to tumble, it can tumble in which case the power engine positioned in the upper section of the machine and important components associated therewith will hit the ground and be damaged, thereby disabling the machine.

An attempt has been made to solve this problem guarding the power engine with a metallic cover plate from the outside in order to prevent the machine body, in particular the power engine components, from damage when the rammer tumbles in a state where it is supported on the ground by the compaction plate.

However, the following problem is associated with the structure in which the power engine is guarded from the outside with a metallic cover plate. The cover plate serves to prevent the power engine components from damage when the machine tumbles, but when the cover plate is made from a thin metal sheet, the strength of the cover is insufficient to withstand the impact when the machine tumbles, the cover is deformed, and the power engine components cannot be prevented from damage.

On the other hand, when a thick metallic cover is used to prevent the cover plate from damage, the cover withstands the impact when the machine tumbles and the damage of power engine components caused by the deformation of the cover plate can be prevented, but due to the additional weight of the cover plate, the weight of the upper section of the machine body increases, thereby further raising the probability of tumbling, and a negative pressure load necessary to cause the machine to jump increases, thereby adversely affecting the compaction function of the rammer.

Multiple open sections can be provided in order to decrease the weight of the thick cover plate with the object of solving the above-described problems encountered when a thick metallic cover plate is used, but providing multiple open sections in the entire surface of the cover decreases endurance.

Furthermore, because the open sections are provided by pressing a metal plate, the open section of corresponding adequate shape is difficult to provide, for example, in an exhaust pipe position of the muffler or in a position where the link of a throttle wire can be adjusted from the outside. As a result, only about two open sections are provided in the left and right cover plate, but the resultant problem is that an exhaust heat is retained between the left and right cover plates, and this exhaust head cannot be adequately discharged to the outside of the machine.

### SUMMARY OF THE INVENTION

It is an object of present invention to provide a protective cover structure for a rammer in which, as a means for solving the problems inherent to the conventional protective cover structure for a rammer, a cover plate for guarding the power engine is molded from a synthetic resin that makes it possible to obtain any shape and has small weight, high strength, and impact absorption ability, and this cover plate is configured so that it can be assembled and disassembled by simple operations, has good endurance with respect to severe vibrations and can reduce significantly the damage of the machine body due to the adequate impact absorption ability even when the rammer tumbles.

As a specific means for resolving the above-described problems, the protective cover structure for a rammer in accordance with the present invention comprises a leg section extendable downward a crank chamber that converts a rotary movement of a power engine into an up-down movement and a compaction plate at the lower end of the leg section, and in which the up-down movement inside the crank chamber is transmitted to the compaction plate via the resilience of a coil spring disposed inside the leg section, wherein the protective cover structure comprises below a rear surface of the crank chamber a protective stand that has a function of protecting a lower-half section of the power engine and that comprises in a protruding condition a support frame for supporting from below guard covers disposed on both sides of the crank chamber and power engine along both sides, the guard covers for protecting both side surfaces of the crank chamber and power engine are disposed at the outer surface on both sides of the crank chamber and power engine, the front end sections of respective guard covers on the side of the crank chamber are joined and fixed to a circumferential section of the front surface plate of the crank chamber, the lower side section of the power engine is supported and fixed by the support frame of the protective stand, and upper parts of the rear sections of both guard covers on the side of the power engine are linked and fixed integrally by a linking transverse pole.

A configuration is preferred in which the protective stand provided below the rear surface of the crank chamber and having a function of protecting a lower-half section of the power engine comprises a base plate attached to the lower surface of the power engine, a power engine protective plate that extends from the rear section of the base plate so that the distal end is curved in a sledge-like manner, and support frames in which rod-like bodies extending in the left-right direction from both sides of the base plate are bent to produce a peak-like shape when viewed from the side surface.

Furthermore, it is preferred that the linking transverse pole linking the upper parts of the rear sections of the left and right guard covers on the side of the power engine has at both ends thereof leg sections in the directions perpendicular to the longitudinal direction of the linking transverse pole, and the upper and lower ends of the leg sections are linked and fixed between the upper parts of the rear sections of both guard covers on the side of the power engine.

The protective cover structure in accordance with the present invention comprises below a rear surface of the crank chamber a protective stand that has a function of protecting a lower-half section of the power engine and comprises in a protruding condition thereof support frames for supporting from below the guard covers disposed on both sides of the crank chamber and power engine along both sides. Therefore, when the rammer tumbles to the right or to the left, the impact is absorbed by the support frame and the rear section of the guard cover, and the power engine can be prevented from damage.

The guard cover is formed from a synthetic resin, has a small weight, and can be molded to any shape. A high strength is attained even when the guard cover has a large shape such that can cover not only the side surface of the power engine, but also both sides of the crank chamber and power engine. Furthermore, an effective shape can be obtained that enables a free selection of optimum conditions for the guard cover such as the position of a ventilation hole through which the exhaust gas obtained after the power engine has been cooled has to be discharged and a shape that has to be provided to a protruding components such as a muffler.

Furthermore, the guard cover made from a synthetic resin has a small weight and a high strength, excels in resilience and has an impact absorption capability. Therefore, the guard cover demonstrates endurance against severe vibrations and can absorb adequately an impact force and substantially reduce the damage of the machine body even when the rammer tumbles.

Furthermore, with the protective cover structure in accordance with the present invention, when a cover attachment operation is performed, first, the guard covers that are to be disposed on both sides of the crank chamber and power engine are disposed so that the front end sections thereof on the crank chamber side are joined to a circumferential section of the front plate on the crank chamber side and so that the lower sections on the power engine side are supported by the support frames of the protective stand provided at the lower surface of the power engine and the lower sections on the side of the power engine are secured with bolts to the support frames of the protective stand, thereby ending the basic arrangement operation of the guard covers on both sides. Then, the entire attachment operation is completed by linking integrally the upper portions of the rear sections of both guard covers on the side of the power engine by a linking transverse pole. Therefore, the attachment operation can be performed efficiently.

### BRIEF DESCRIPTION OF THE DRAWINGS

FIG. 1 is a perspective view illustrating the basic configuration of the protective cover structure in accordance with the present invention;

FIG. 2 is a perspective view illustrating the shape of the protective stand provided at the lower surface of the power engine;

FIG. 3 is a side view of the protective stand shown in FIG. 2;

FIG. 4 is a side view of a rammer in which the protective cover structure in accordance with the present invention has been implemented;

FIG. 5 is a side view illustrating the shape of the opposite side of the rammer shown in FIG. 4;

FIG. 6 is a perspective view of the front surface side of the rammer in which the protective cover structure in accordance with the present invention has been implemented; and

FIG. 7 is a perspective view from the rear surface side of the rammer shown in FIG. 6.

### DESCRIPTION OF THE PREFERRED EMBODIMENTS

The front end sections of the guard covers on the crank chamber side are joined to a circumferential section of the front plate on the crank chamber and then the lower sections on the power engine side are supported by the support frames of the protective stand provided at the lower surface of the power engine and the lower section on the power engine side is secured with bolts to the support frames of the protective stand, thereby ending the basic arrangement operation of the guard covers on both sides. However, in terms of reinforcement, it is preferred that bolts be inserted from the outside of ventilation ports into the threaded holes provided on the inner side of some ventilation ports.

### Embodiments

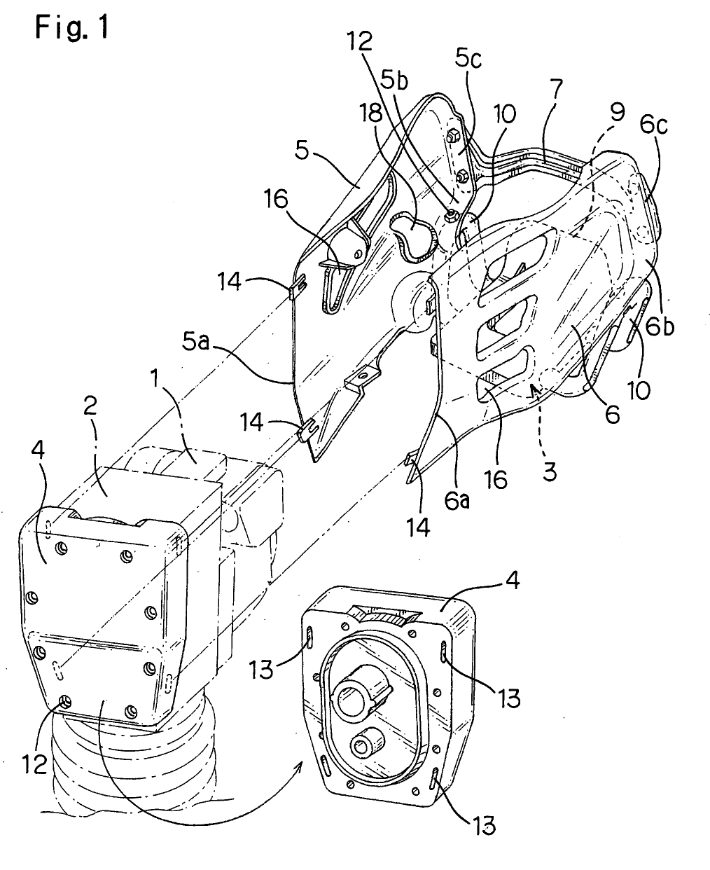

The protective cover structure for a rammer in accordance with the present invention will be explained below based the embodiment thereof illustrated by FIG. 1. FIG. 1 is a perspective view illustrating the basic configuration of the protective cover structure. This protective cover structure comprises a power engine protective stand 3 attached to the lower surface of a power engine 1 that is connected and fixed to the rear surface of a crank chamber 2, a front plate 4 attached to the front surface of the crank chamber 2, a pair of left and right guard covers 5, 6 disposed on the outer surface on both sides of the crank chamber 2 and power engine 1, and a linking pole 7 for linking integrally the upper portions of the rear sections of both guard covers 5, 6 on the power engine side.

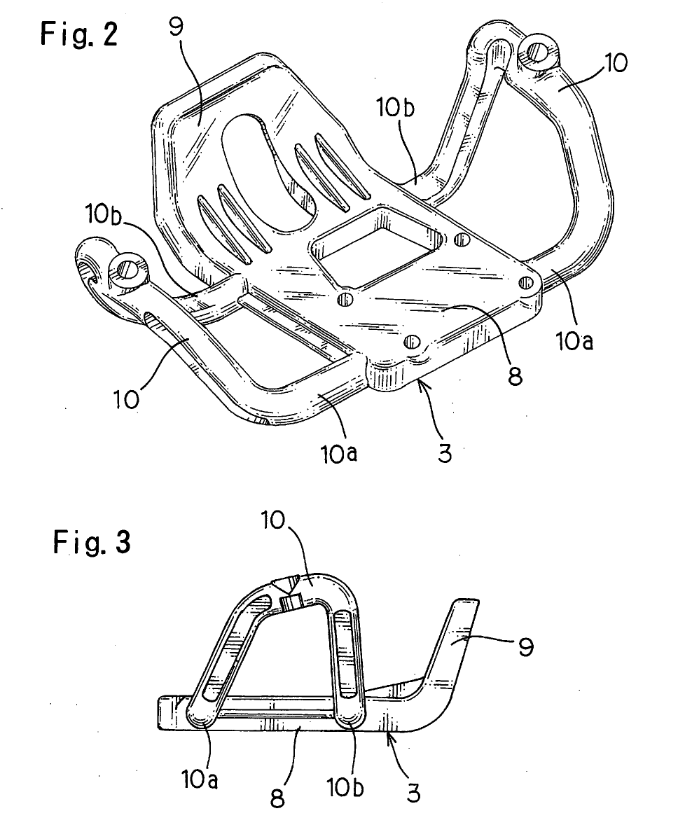

As shown in FIG. 2 and FIG. 3, the power engine protective stand 3 is molded from a Nylon resin or the like and serves to protect the lower-half section of the power engine 1 when the rammer tumbles. The protective stand comprises a base plate 8 for attachment to the lower surface of the power engine 1, a protective plate 9 for the power engine 1 that has a distal end thereof extending in a sledge-like fashion from the rear section of the base plate 8 in the direction of the front surface of a recoil stator 1a of the power engine 1 and that is curved so that the recoil starter 1a can be guarded thereby, and support frames 10 in which a pair of rod-shaped bodies 10a, 10b are extended parallel to each other in the left and right direction from both sides of the base plate 8 and bent so that a peak-like shape is formed, in a side view thereof, by the central sections of the distal ends of the rod-shaped bodies 10a, 10b.

Guard covers 5, 6 for protecting both side surfaces of the crank chamber 2 and power engine 1 are disposed at the outer surfaces on both sides of the crank chamber 2 and power engine 1, the front end sections 5a, 6a of the respective guard covers 5, 6 on the crank chamber side are joined and fixed to the circumferential section of the front plate 4 of the crank chamber 2, and in this state the lower sections 5b, 6b of the guard covers 5, 6 on the power engine side are supported and fixed by the support frames 10 of the protective stand 3.

The front plate 4 of the crank chamber 2 is fixed by bolts 12 to the front surface of the crank chamber 2. In the rear surface (shown by an arrow in FIG. 1) of the front plate 4, a plurality of insertion grooves 13 are provided in advance in the circumferential section. On the other hand, protrusions 14 for fitting into the insertion grooves 13 of the front plate 4 are provided at the front end sections 5a, 6a of the guard covers 5, 6 on the crank chamber side, and the process of connecting the front end sections 5a, 6a of the guard covers 5, 6 on the crank chamber side to the crank chamber 2 is completed by inserting the protrusions 14 of the front end sections 5a, 6a on the crank chamber side into the insertion grooves 13 of the front plate 4.

When the front end sections 5a, 6a of the guard covers 5, 6 on the crank chamber side are connected to the crank chamber 2 by inserting the protrusions 14 of the front end sections 5a, 6a on the crank chamber side into the insertion grooves 13 of the front plate 4, the attachment position of the guard covers 5, 6 is determined and the lower sections 5b, 6b of the guard covers 5, 6 on the power engine side are automatically supported by the apex sections of the peak-shaped support frames 10 of the protective stand 3. Therefore, the lower sections 5b, 6b on the power engine side and the peak-shaped support frames 10 of the protective stand 3 are connected and fixed by bolts 12.

After the lower sections 5b, 6b on the power engine side have been connected to the peak-shaped support frames 10 of the protective stand 3, a linking transverse pole 7 is disposed between the rear sections 5c, 6c of both guard covers 5, 6 on the power engine side. The linking transverse pole 7 preferably has a shape such that comprises at both ends thereof leg sections 15 extending in the direction perpendicular to the longitudinal direction of the linking transverse pole 7, and the upper and lower ends of the leg sections 15 are linked and fixed to the rear sections 5c, 6c of both guard covers on the power engine side.

By attaching the transverse pole 7, vibrations of the rear sections 5c, 6c in the guard covers 5, 6 at both sides are suppressed and stable and reliable fixing is enabled. Furthermore, the transverse pole 7 also serves as a guard for the upper section of the power engine 1.

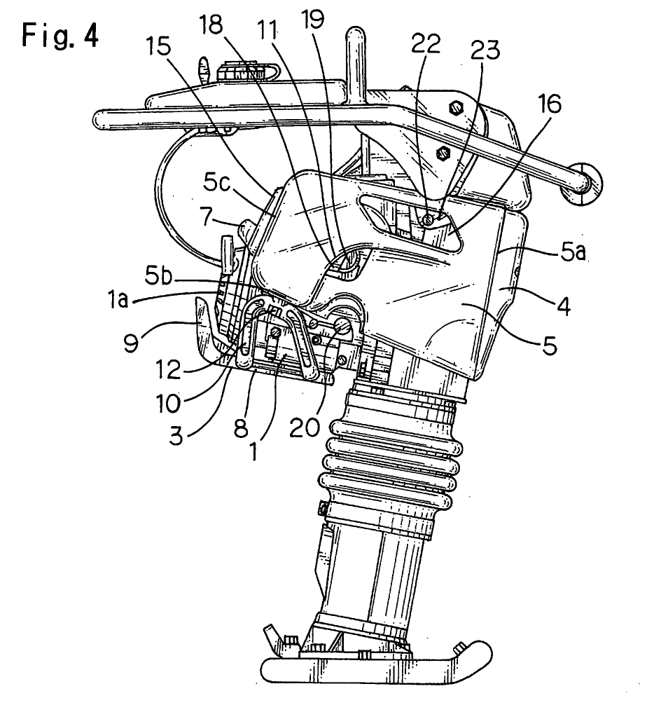

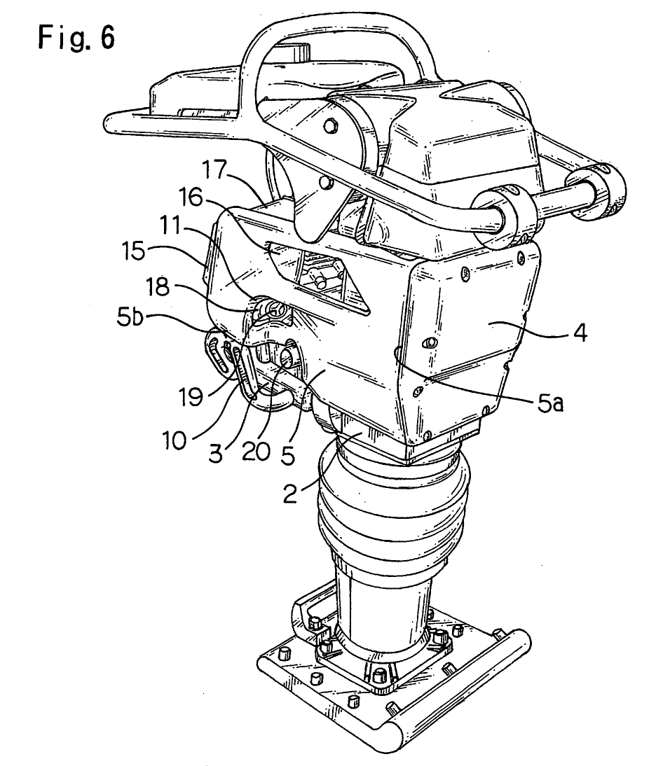

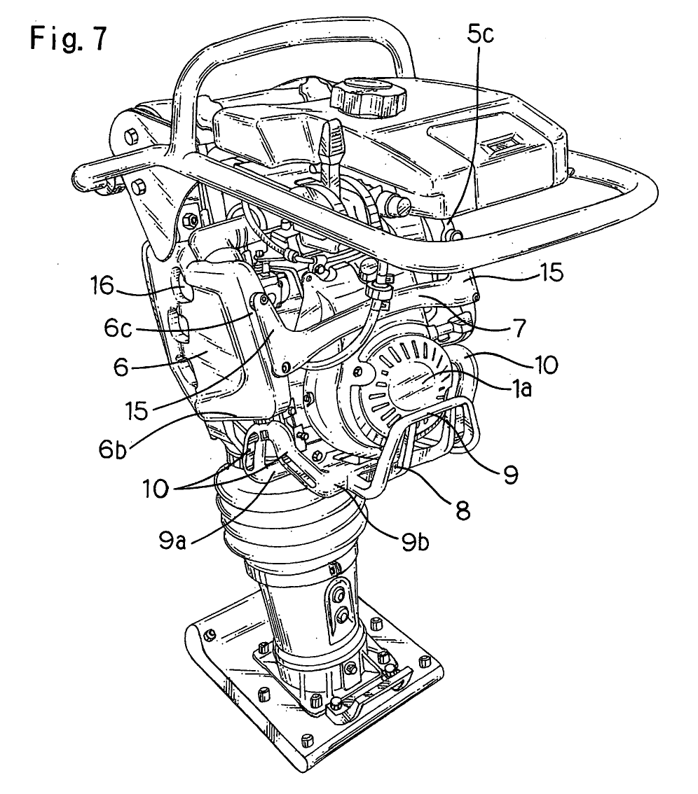

The shape of the guard covers 5, 6 can be freely designed according to the shape of components such as a carburetor or a muffler disposed on the outside of the power engine 1, and the preferred shape, number, and location can be also selected for ventilation ports 16 for discharged high-temperature air generated around the power engine 1. Furthermore, as shown in FIG. 4 and FIG. 6, because a muffler 17 of the power engine 1 protrudes through the guard cover 5 on the left side of the machine body, the configuration is such that a step section 11 is provided so that the surface on the crank chamber side is low and the surface on the power engine side is high, an open section 18 is provided, and an exhaust port 19 of the muffler 17 is positioned in the open section 18.

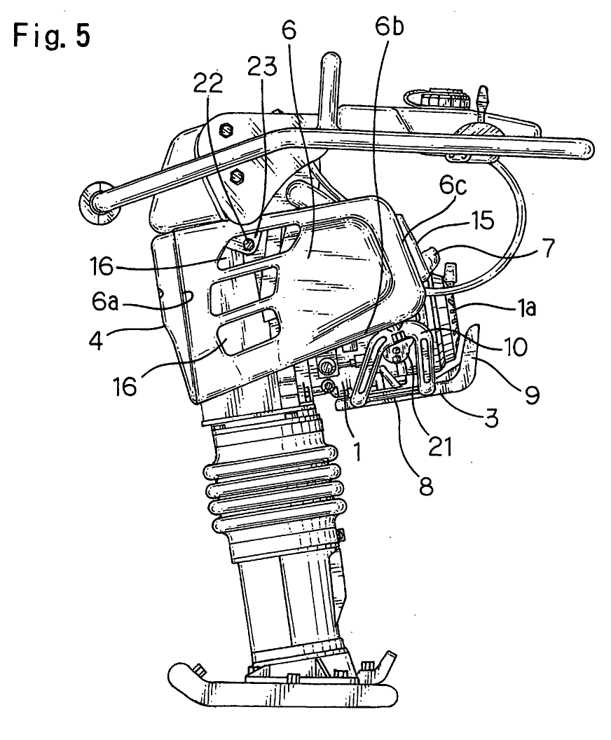

As follows from FIG. 4 and FIG. 5, the lower sections 5b, 6b of the guard covers 5, 6 on the power engine side are supported by the apex sections of the peak-shaped support frames 10 protruding upward in the form of a bent pipes from both ends surfaces of the protective stand 3 provided at the low surface of the power engine 1. Therefore, a gap sufficient to insert fingers can be provided between the support frames 10. As a result, for example, an operation of filling up oil via an oil filling port 20 of the engine, such as shown in FIG. 4, the adjustment of a link 21 for engine revolution speed adjustment shown in FIG. 5, or throttle wire replacement operation can be freely performed.

In the above-described embodiment, linking and fixing of the guard covers 5, 6 was described to be completed by inserting the protrusions 14 of the front end sections 5a, 6a on the crank chamber side into the insertion grooves 13 of the front plate 4, securing the lower sections 5b, 6b on the power engine side to the apex sections of the peak-shaped support frames 10 of the protective stand 3 with bolts, and linking both ends of the transverse pole 7 between the rear sections 5c, 6c on the power engine side. This description indicates that in accordance with the present invention the guard covers 5, 6 basically can be linked in the above-described three places. In terms of reinforcement, it is preferred that pieces 23 having threaded holes 22 be provided on the inner side of some ventilation ports 16 so that the bolts 12 can be inserted from the outside of the ventilation ports 16 into the threaded holes 22 and connected and fixed to the crank chamber 2.

Furthermore, in the above-described embodiment, a configuration in which protrusions 14 were provided in the front end sections 5a, 6a on the crank chamber side and those protrusions 14 were inserted into the insertion grooves 13 of the front plate 4 was used as means for joining and fixing the guard covers 5, 6, but the front end sections 5a, 6a on the crank chamber side may be also joined to the front plate 4 or side surface of the crank chamber by bolts.

In accordance with the present invention, the lightweight guard covers 5, 6 that have a vibration absorption capability can be connected and fixed in a simple manner by inserting the protrusions 14 of the front end sections 5a, 6a on the crank chamber side into the insertion grooves 13 of the front plate 4, securing the lower sections 5b, 6b on the power engine side to the apex sections of the peak-shaped support frames 10 of the support stand 3 with bolts, and linking both ends of a transverse pole 7 between the rear sections 5c, 6c on the power engine side. Therefore, a rammer with an excellent protective function provided for by the guard covers can be produced efficiently.

What is claimed is:

1. A protective cover structure for a rammer comprising a leg section extendable downward a crank chamber that converts a rotary movement of a power engine into an up-down movement and a compaction plate at the lower end of the leg section and in which the up-down movement inside the crank chamber is transmitted to the compaction plate via resilience of a coil spring disposed inside the leg section, wherein
said protective cover structure comprises below a rear surface of the crank chamber a protective stand that has a function of protecting a lower-half section of the power engine and that comprises in a protruding condition a support frame for supporting from below guard covers disposed on both sides of the crank chamber and power engine along both sides, the guard covers for protecting both side surfaces of the crank chamber and power engine are disposed at the outer surface on both sides of the crank chamber and power engine, the front end sections of respective guard covers on the side of the crank chamber are joined and fixed to circumferential section of the front surface plate of the crank chamber, the lower side section of the power engine is supported and fixed by the support frame of said protective stand, and upper parts of the rear sections of both guard covers on the power engine side are linked and fixed integrally by a linking transverse pole.

2. The protective cover structure of a rammer according to claim 1, wherein the protective stand provided below the rear surface of the crank chamber and having a function of protecting a lower-half section of the power engine comprises a base plate for attachment to the lower surface of the power engine, a power engine protective plate that extends from the rear section of the base plate so that the distal end thereof is curved in a sledge-like fashion, and support frames in which rod-like bodies extending in the left-right direction from both sides of the base plate are bent to produce a peak-like shape in a side view thereof.

3. The protective cover structure of a rammer according to claim 1, wherein the linking transverse pole linking the upper parts of the rear sections of the left and right guard covers on the side of the power engine has at both ends thereof leg sections extending in the direction perpendicular to the longitudinal direction of the linking transverse pole, and the upper and lower ends of the leg sections are linked and fixed between the upper parts of the rear sections of both guard covers on the side of the power engine.
